(19) United States
(12) Patent Application Publication
(10) Pub. No.: US 2015/0005677 A1
(43) Pub. Date: Jan. 1, 2015

(54) Passive exercise bed

(71) Applicant: Sung-Chu Liao, Taipei City (TW)

(72) Inventor: Sung-Chu Liao, Taipei City (TW)

(21) Appl. No.: 13/931,826

(22) Filed: Jun. 29, 2013

(51) Int. Cl. A61H 1/02

(52) U.S. Cl. CPC A61H 1/02; A61H 2203/0456; A61G 2210/10
USPC 601/5

(57) ABSTRACT

A passive exercise bed is disclosed. The passive exercise bed of the present invention comprises a main body, a back fixing unit, a head fixing unit, two arm fixing units, a hip unit, a plurality of extendable units, a plurality of leg fixing units and a control unit. Several driving units are disposed inside the main body and may be activated through the control unit to move or drive the head fixing unit, two arm fixing units, hip unit and extendable units. Therefore, the passive exercise bed of the present invention may be used to stretch out our waist, leg joints, upper body, shoulders, arm joints, elbow joints, wrist joints, the two sides of waist and back as well as hip joints.

### BACKGROUND OF THE INVENTION

1. Field of the Invention

The invention generally relates to a passive exercise bed. More particularly, the invention relates to a passive exercise bed that may be used to stretch out various parts of our body via manual or automatic control and that may provide passive exercise to bedridden, severely ill and disabled people.

2. Description of the Prior Art

Warm-up or stretch-out may reduce or eliminate bodily injuries in exercise or sports because it can prevent sports injuries, lessen the pain caused by muscular stiffness, enhance sports performance and increase the flexibility in tendons and joints as well as prevent the strain-induced tendon inflammation.

Manual laborers are not the only people who are prone to the strain-induced tendon inflammation. Long-term excessive use of the same tendon would cause excessive frictions between the tendon and its surrounding tendons and would cause the strain-induced tendon inflammation. For example, workers who work on a production line and use their hands to assemble products are prone to the strain-induced tendon inflammation because they overuse the same tendon(s). Therefore, the strain-induced tendon inflammation may be regarded as an occupational disease. Also, an ordinary inflammation may be alleviated by ice and may not be alleviated by massage or rubbing. On the other hand, massage and rubbing is needed to alleviate the strain-induced tendon inflammation. Stretching exercise can prevent and cure the strain-induced tendon inflammation.

### SUMMARY OF THE INVENTION

An object of the present invention is to provide a passive exercise bed that may be used to stretch out various parts of our body via manual or automatic control.

Another object of the present invention is to provide a passive exercise bed that may provide passive exercise to bedridden and severely ill people.

To reach the objects, the passive exercise bed of the present invention is disclosed. The passive exercise bed of the present invention comprises a main body, a back fixing unit, a head fixing unit, two arm fixing units, a hip unit, a plurality of extendable units, a plurality of leg fixing units and a control unit. The back fixing unit is fixedly connected with and on top of the main body. A user's upper body may lie flat on the back fixing unit with his chest facing up or down. The head fixing unit consists of two fixing parts, which can fix the head in between. The hip unit may support the hip and waist. A handle is provided at the proximal end of either arm fixing unit for the user's hand to grab onto. Several driving units are disposed inside the main body and may be activated through the control unit to move or drive the head fixing unit, two arm fixing units, hip unit and extendable units. Therefore, the passive exercise bed of the present invention may be used to stretch out our waist, leg joints, upper body, shoulders, arm joints, elbow joints, wrist joints, the two sides of waist and back as well as hip joints.

### BRIEF DESCRIPTION OF THE DRAWINGS

FIG. 1 is a perspective view illustrating the passive exercise bed of the present invention.

FIG. 2 is a perspective view illustrating the passive exercise bed of the present invention in operation.

FIG. 3 is a perspective view illustrating a user's hand may grab onto a handle of the passive exercise bed of the present invention.

FIG. 4 is another perspective view illustrating the passive exercise bed of the present invention in operation.

FIG. 5 is a third perspective view illustrating the passive exercise bed of the present invention in operation.

FIG. 6 is a fourth perspective view illustrating the passive exercise bed of the present invention in operation.

List of reference numerals

| | | | |
|---|---|---|---|
| 1 | Main body | 2 | Back fixing unit |
| 3 | Head fixing unit | 31 | Two fixing parts |
| 4 | Two arm fixing units | 41 | Handles |
| 5 | Hip unit | 6 | Extendable units |
| 61 | Holes | 7 | Leg fixing units |
| 71 | Pins | 8 | Control unit |

### DETAILED DESCRIPTION OF THE PREFERRED EMBODIMENT

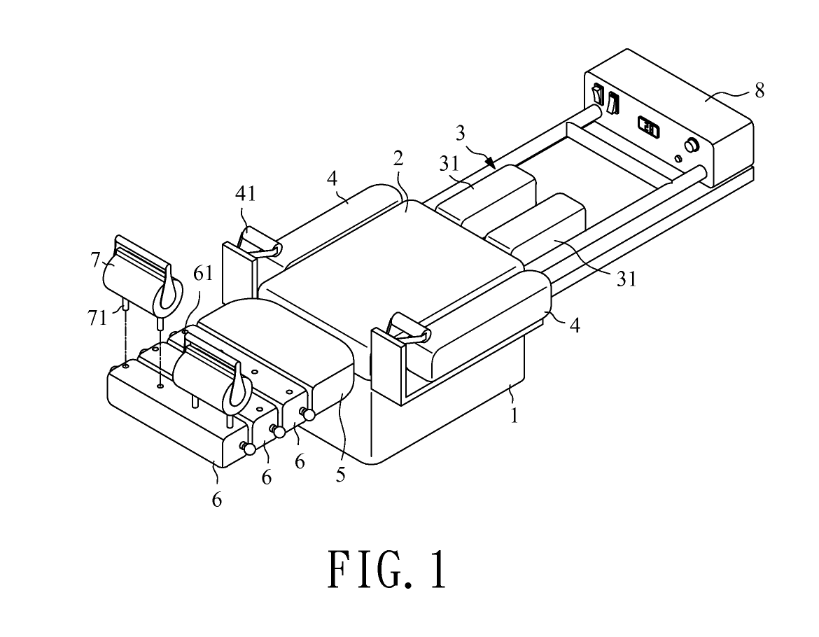

Please see FIG. 1. The passive exercise bed of the present invention comprises a main body 1, a back fixing unit 2, a head fixing unit 3, two arm fixing units 4, a hip unit 5, a plurality of extendable units 6, a plurality of leg fixing units 7 and a control unit 8. Several driving units are disposed inside the main body 1 and may be activated through the control unit 8 to move or drive the head fixing unit 3, two arm fixing units 4, hip unit 5 and extendable units 6. The back fixing unit 2 is fixedly connected with and on top of the main body 1. A user's upper body may lie flat on the back fixing unit 2 with his chest facing up or down. One or more straps are provided on the back fixing unit 2 to fix the upper body. The head fixing unit 3 is disposed on the distal side of the back fixing unit 2. The head fixing unit 3 consists of two fixing parts 31, which can fix the head in between. An arm fixing unit 4 is disposed on either side of the back fixing unit 2. A handle 41 is provided at the proximal end of either arm fixing unit 4 for the user's hand to grab onto. Either handle 41 is connected with the driving units disposed inside the main body 1. The hip unit 5 is disposed at the proximal side of the back fixing unit 2 and can support the hip and waist. The extendable units 6 are disposed on the proximal side of the hip unit 5 and are linked to the latter through driving units. A plurality of holes 61 are provided in the extendable units 6 so that pins 71 of the leg fixing units 7 may be inserted into these holes. The driving units may be hydraulic devices, telescopic devices or transmission devices as long as they can move or drive the head fixing unit 3, two arm fixing units 4, hip unit 5 and extendable units 6.

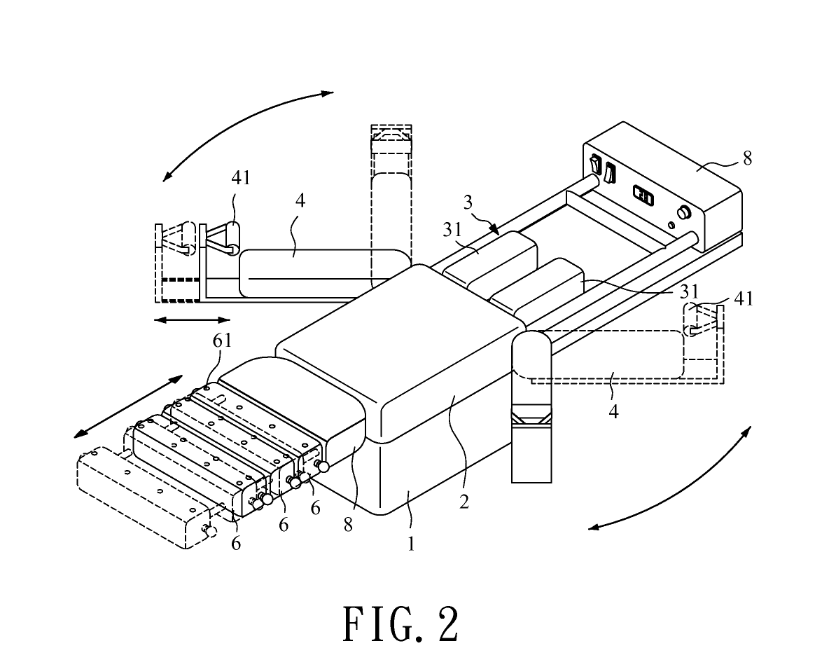

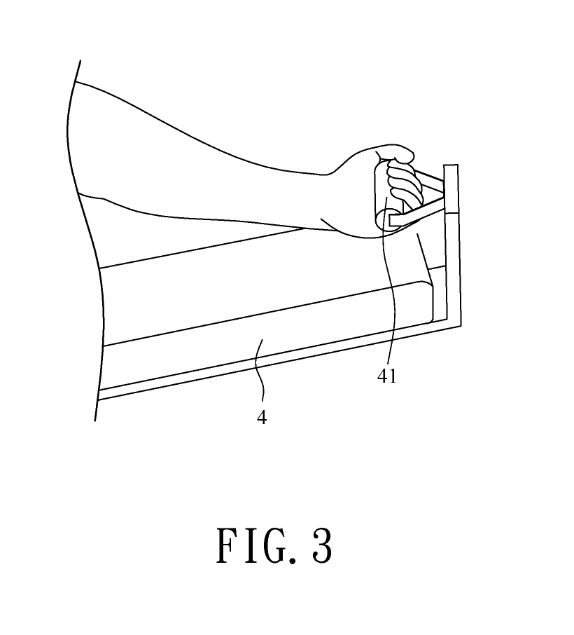

Now, please refer to FIGS. 1, 2 and 3. FIG. 2 illustrates the passive exercise bed of the present invention in operation. When a user lies flat on the bed with his chest facing up or down, his upper body may be supported by the back fixing unit 2 and his waist and hip may be supported by the hip unit 5. In addition, the straps may be used to fix his upper body and his head may be fixed by the head fixing unit 3. Also, the leg fixing units 7 may be used to fix his legs on the extendable units 6 and his hands may grab onto the two handles 41. Now, the user may use the control unit 8 to activate the driving units to extend the extendable units 6 to stretch out his waist and knees. Also, because his head is fixed by the two longitudinally oriented parts 31, such longitudinal extension would not twist his neck. Optionally, an additional neck fixing portion may be provided and used so as to extend the neck; in such case, a trained medical person should be present to supervise the process so as to avoid accidents that may hurt the neck. Moreover, the user may use the control unit 8 to prompt the driving units to move the two arm fixing units 4 sideways and horizontally so as to stretch out the arms. Furthermore, either handle 41 may be extended outwards so as to stretch out upper arm joint, elbow and wrist. Because either arm is moved sideways and horizontally as the handle 41 is extended outwards, the user may let go of the handles 41 to avoid injuries if any discomfort is generated.

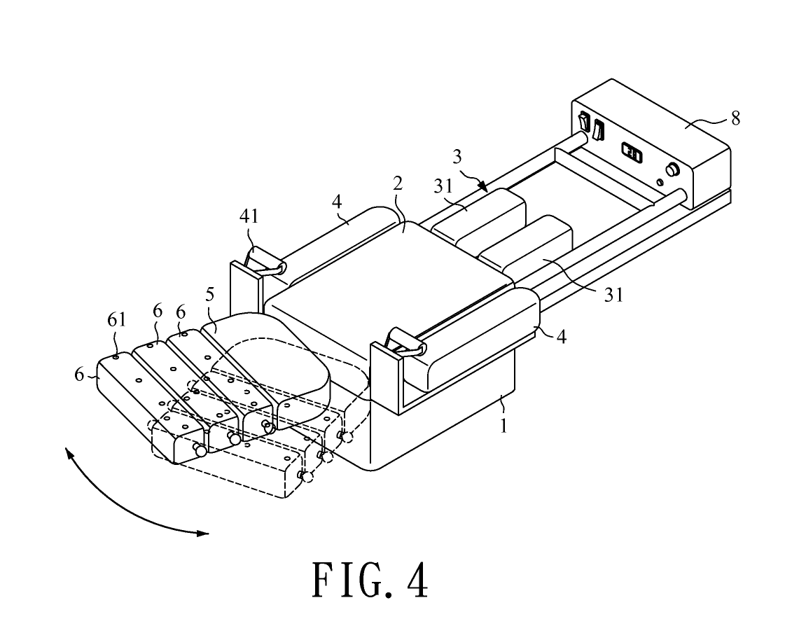

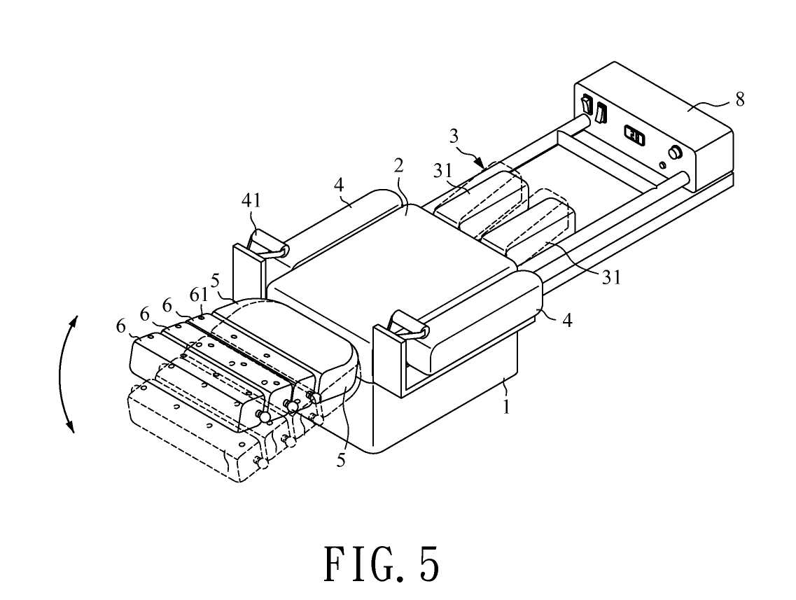

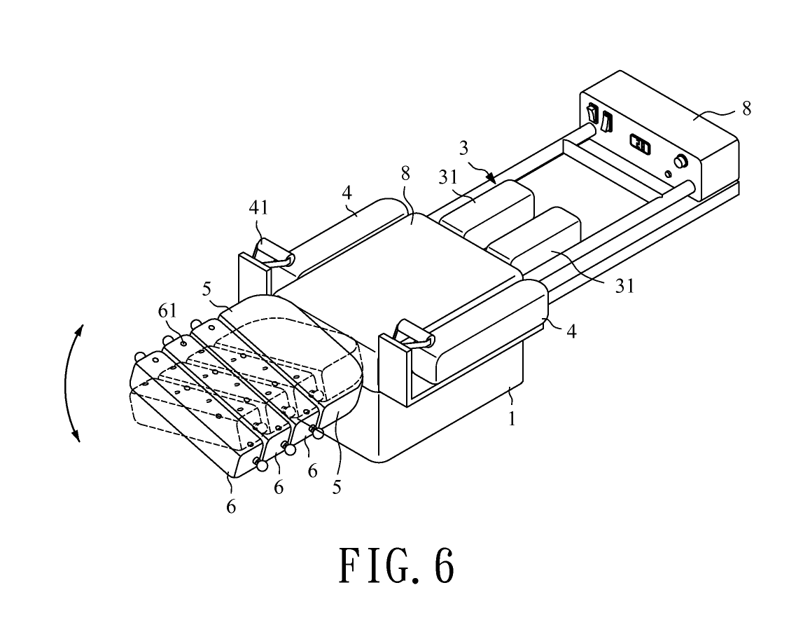

Now, please refer to FIGS. 1, 4 and 5. FIG. 4 illustrates the hip unit 5 and the extendable units 6 may be moved sideways and horizontally. FIG. 5 illustrates that head fixing unit 3, the hip unit 5 and the extendable units 6 may be moved up and down. In FIG. 4, the straps are used to fix the upper body and the head is fixed by the head fixing unit 3; in addition, the leg fixing units 7 are used to fix his legs on the extendable units 6. Then, a user may use the control unit 8 to activate the driving units to move the hip unit 5 and the extendable units 6 sideways and horizontally so as to provide passive exercise to the waist. In FIG. 5, both the head and the waist are moved up and down so as to stretch out the back. In FIG. 6, a user may use the control unit 8 to activate the driving units to rotate the hip unit 5 and the extendable units 6 so as to rotate the waist and stretch out the hip joints.

As previously explained, the passive exercise bed of the present invention may be used to stretch out our waist, leg joints, upper body, shoulders, arm joints, elbow joints, wrist joints, the two sides of waist and back as well as hip joints. Therefore, the passive exercise bed of the present invention may be used for healthy people as well as bedridden and severely ill people.

Although a preferred embodiment of the present invention has been described in detail hereinabove, it should be understood that the preferred embodiment is to be regarded in an illustrative manner rather than a restrictive manner, and all variations and modifications of the basic inventive concepts herein taught still fall within the scope of the present invention.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A passive exercise bed, comprising:
a main body, in which several driving units are disposed;
a back fixing unit, fixedly connected with and on top of the main body;
a head fixing unit, disposed on the distal side of the back fixing unit and connected with the main body by driving units;
two arm fixing units, connected with the main body by driving units, characterized in that one arm fixing unit is disposed on the right hand side of the back fixing unit and the other arm fixing unit is disposed on the left hand side of the back fixing unit;
a hip unit, connected with the main body by driving units, characterized in that the hip unit is disposed on the proximal end of the back fixing unit;
a plurality of extendable units, connected with the hip unit by driving units, characterized in that a plurality of holes are provided in the extendable units;
a plurality of leg fixing units, characterized in that pins of the leg fixing units may be inserted into the holes; and
a control unit, characterized in that the driving units may be activated through the control unit to move or drive the head fixing unit, two arm fixing units, hip unit and extendable units.

2. The passive exercise bed as in claim 1, wherein one or more straps are provided on the back fixing unit and may be used to fix the upper body.

3. The passive exercise bed as in claim 1, wherein the head fixing unit consists of two fixing parts, which can fix the head in between.

4. The passive exercise bed as in claim 1, wherein a handle is provided at the proximal end of either arm fixing unit.

5. The passive exercise bed as in claim 1, wherein the driving units may be hydraulic devices.

6. The passive exercise bed as in claim 1, wherein the driving units may be telescopic devices.

7. The passive exercise bed as in claim 1, wherein the driving units may be transmission devices.
